(19) United States
(12) Patent Application Publication
(10) Pub. No.: US 2003/0172746 A1
(43) Pub. Date: Sep. 18, 2003

(54) Airflow Sensor

(76) Inventors: Mark A. Walker, Dallas, TX (US); Kuang Tung Wu, Dallas, TX (US)

Correspondence Address: CALFEE HALTER & GRISWOLD, LLP, 800 SUPERIOR AVENUE, SUITE 1400, CLEVELAND, OH, 44114, US

(21) Appl. No.: 10/099,773

(22) Filed: Mar. 15, 2002

(51) Int. Cl. G01F 1/46

(52) U.S. Cl. 73/861.65

(57) ABSTRACT

A flow rate sensor may have arms extending outwardly from a central axis or hub, with an aerodynamic upstream surface on each arm, and a blunt downstream surface that creates a reduced pressure zone adjacent to the blunt surface. At least one high-pressure fluid inlet is located in the aerodynamic upstream surface, and at least one low-pressure inlet is located in the reduced pressure zone downstream from the blunt surface. This combination of an aerodynamic upstream surfaces and a blunt face on the downstream side of the sensor generates an amplified signal that is suitable for modern controllers, and is significantly quieter than previous sensors.

### TECHNICAL FIELD

This invention relates to airflow sensors. More particularly, it relates to sensors that average and amplify pressure differential signals from several locations within a duct.

### BACKGROUND

Accuracy of airflow control is critical to the performance of heating, ventilating, air conditioning and other systems for supplying air, other gases or vapors (referred to collectively herein as “air”) through ducts. It impacts many important aspects, ranging from acoustics to occupant comfort. The volumetric flow rate of air is typically controlled by placing a sensor in the duct, and transmitting a differential pressure signal that is representative of the volumetric flow rate to a controller for comparison with a signal representative of the desired volumetric flow. When the actual flow does not correspond to the desired flow, the controller automatically adjusts a damper or the like in the duct in order to establish the actual flow at the desired rate.

Well-designed and repeatable airflow sensors are key to accurate flow control in these systems. While there have been many improvements to both flow transducers and controller software/algorithms from the controls industry, all are dependent on an accurate signal from a flow sensor. A flow sensor that can measure accurately regardless of inlet conditions simplifies and takes much of the guesswork out of the balancing and commissioning process.

Providing accurate flow sensing for a terminal unit is a delicate balancing act. There are several requirements that must be achieved simultaneously, without sacrificing one performance aspect for another. Ideally a flow sensor should provide high flow signal amplification and immunity from poor inlet conditions, while keeping pressure drop and sound levels to a minimum. In addition, a flow sensor should have a high degree of repeatability and sturdy construction.

Characteristics that describe the performance and suitability of a flow sensor include:

Amplification: Put simply, amplification is the ability of a flow sensor to produce a signal greater than the velocity pressure, i.e. the difference between total pressure (taken from the tip of a standard pitot tube) and static pressure (taken from the side of a standard pitot tube). Pitot tubes read true velocity pressure. Amplified flow sensors improve upon this signal by taking the difference between total pressure (from the front of the probe) and a reduced pressure (from the rear of the probe), thus providing a higher signal-to-noise ratio than pitot tubes. Amplification is critical to accurate control of minimum flow rates. While many digital controllers have made great gains in processing low pressure signals accurately, a sensor should be capable of providing a signal of sufficient magnitude for any type of controller to monitor easily.

Inlet Sensitivity: Inlet sensitivity is a measure of flow sensing accuracy that can be lost to less-than-ideal inlet conditions. Although the Sheet Metal & Air Conditioning Contractors National Association recommends a minimum of three duct diameters of straight duct in front of any flow measuring device, this is often not the case. Real world conditions and obstructions such as plumbing, conduit, and structural members result in jogs and turns in both rigid and flexible supply ductwork. Some flow sensors will indicate a flow rate that is incorrect by as much as 30% if located directly downstream of a 90 degree bend. Ideally, a good flow sensor should be able to read air volume to ±5% accuracy, no matter what the inlet conditions may be. This is critical to guarantee the accuracy of factory-calibrated controls, and avoid the need for field calibration. It should be noted that, if excessive inlet sensitivity results in an inaccurate flow signal for a given flow volume, the benefit of amplification has been lost. No controller, regardless of its sophistication, can overcome less-than-adequate accuracy from a flow sensor.

Pressure Drop: Like every item placed in the air stream, a flow probe will increase the pressure drop that the fan system must overcome to provide the required airflow. Minimizing the pressure drop caused by the probe reduces the fan energy required to deliver the required airflow. While many flow probes have very low pressure drop, they do so by giving up any amplification of the pressure signal. Our invention provides high amplification at lower pressure drop than previously thought possible.

Acoustics: At low inlet velocities, all flow probes are very quiet. In order to avoid sound generation in an inlet, it is recommended that units be selected for inlet velocities of 2000 FPM or less. At these velocities, a good flow sensor should not generate objectionable noise. Typically, a designer should expect noise criteria (NC) levels in the range of NC-18 to NC-23.

With the predominant use of digital controls, flow-sensing probes are again viewed as the weak link in the control loop. A demand for accurate flow sensing regardless of inlet conditions resulted in the development of center-averaging, multi-point sensors. Amplified flow sensing probes, developed approximately twenty-five years ago, provided a flow signal of sufficient magnitude to control both minimum and maximum flow limits with the pneumatic controllers of the day. One such sensor is illustrated in U.S. Pat. No. 4,453,419 to Engelke (referred to herein as Engelke). This sensor has an array of sensing tubes distributed around and across various types of ducts. The simplest sensor has an array of parallel upstream and downstream sensing tubes extending outwardly from a central hub. Each tube has several radially spaced holes in the upstream tube. The holes are connected to a central averaging chamber, which in turn is connected to the high pressure side of a controller. The holes in the downstream tubes are connected to a second central averaging chamber, connected to the low pressure side of the controller. This system averages and amplifies the differential pressure signals generated at various points within the duct, but the noise levels generated by the sensor may be objectionable under current standards.

### SUMMARY OF THE INVENTION

This invention provides a flow rate sensing apparatus with an aerodynamic upstream surface and a blunt downstream surface that creates a reduced pressure zone adjacent to the blunt surface. At least one high-pressure fluid inlet is located in the aerodynamic upstream surface, and at least one low-pressure inlet is located in the reduced pressure zone downstream from the blunt surface. This combination of an aerodynamic upstream surfaces and a blunt face on the downstream side of the sensor generates an amplified signal that is suitable for modern controllers, and is significantly quieter than the sensor illustrated in the Engelke patent.

One embodiment of the invention has arms extending outwardly from a central axis or hub. Each arm has an upstream side with an aerodynamic face and at least one high pressure inlet in a central portion of this face, and a downstream side having a blunt face that creates a reduced pressure zone adjacent to the blunt face. The low pressure inlet is located in this reduced pressure zone. As in the Engelke sensor, this embodiment averages pressure differentials at different locations within a duct.

Other features and advantages of this invention will be apparent from the following detailed description.

### DRAWINGS

FIG. 1 is an isometric view of the upstream side of a sensor embodying this invention.

FIG. 2 is an isometric view of the downstream side of the sensor shown in FIG. 1.

FIG. 3 illustrates a circular duct with one of the sensors illustrated in FIGS. 1 and 2.

FIG. 4 illustrates a rectangular duct with a pair of the sensors illustrated in FIGS. 1 and 2.

FIG. 5 is a cross-sectional view along line 5-5 in FIG. 2.

FIG. 6 is a cross-sectional view along line 6-6 in FIG. 5.

FIG. 7 is a cross-sectional view along line 7-7 in FIG. 5.

### DETAILED DESCRIPTION

The sensor shown in the Figures, generally referred to as 10, has four substantially identical arms 15 that are designed to facilitate installation in a wide variety of conventional air ducts, such as those shown in FIGS. 3 and 4 and in the system disclosed in U.S. Pat. No. 4,453,419 to Engelke, the disclosure of which is incorporated herein by reference. The sensors may also be used with more advanced controllers, baffles and the like. Sensing arms 15 extend radially from a central hub 12 of sensor 10. As best seen in FIGS. 1 and 6-7, each sensing arm 15 has an upstream side 17 with an aerodynamic face 19 that allows air to flow smoothly past the sensor, thus reducing the noise and pressure drop created by the system. As shown in FIGS. 6 and 7, the aerodynamic faces 19 of the arms for the illustrated sensor are semicircular in cross section. However, other curved profiles or surfaces such as parabolas or semi-ellipses, faceted surfaces such as polygons which simulate a curved surface, and wedge-shaped profiles may also be used.

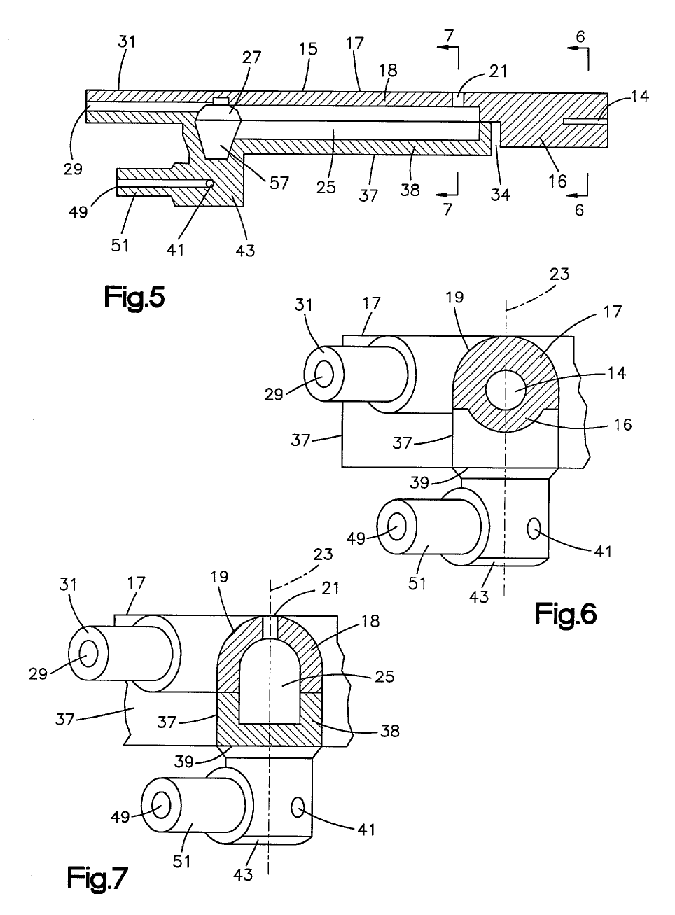

One or more high pressure inlets 21 (shown in FIGS. 5 and 7) are located in a central portion of the upstream side of the arm, preferably on or near the lateral center line 23 of face 19. Each arm of the illustrated sensor has a single port on each arm, positioned to provide a representative signal of the air velocity within the duct. In the illustrated sensors, the inlet ports are located such that they form a “bolt circle” in a cylindrical duct, with roughly half the cross-sectional area outside the circle and half the area inside the circle. If desired, a series of inlets may be provided along each arm, as shown by Engelke. Each high pressure inlet 21 is connected to a conduit 25 which extends inside the arm to a central averaging chamber 27 in air flow communication with the conduits 25 in each of the arms 15. The central averaging chamber is also connected to a conduit 29 through the center of a high pressure tap 31, which connects all the high pressure inlets to the high pressure side of a control system, such as the pneumatic controller shown in the Engelke patent, or an analog or digital controller.

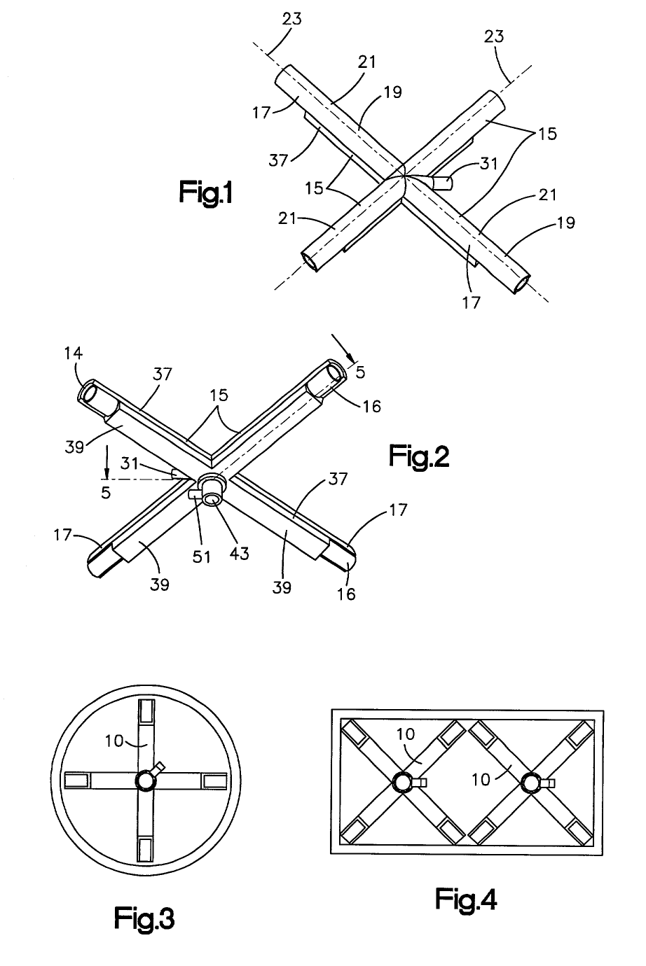

As best seen in FIGS. 2, 6 and 7, the downstream section 37 of each arm 15 has a blunt face 39, preferably flat, although concave or slightly convex surfaces could be used, which generates a reduced pressure zone downstream of the arms. This allows the sensor to produce an amplified pressure signal. A cylindrical hub 43, at the central hub of the sensor, has one or more low pressure inlets 41 positioned in this reduced pressure zone, as shown in FIGS. 5-7. The inlet or inlets 41 are connected to a conduit 49 extending through hub 43 and then through the center of a low pressure tap 51. High pressure tap 31 and low pressure tap 51 are connected, respectively, by tubing to the high and low pressure sides of a controller (not shown) positioned outside the duct.

### EXAMPLE I

Sensors with the features described above (Model ESV, manufactured and sold by Titus, Richardson, Tex.) were compared with older Model ESV sensors (generally similar to the apparatus set forth in the Engelke patent) in tests conducted in accordance with American Refrigeration Institute Standard AR1-880-98 and ANSI Standard S12.31-1990 (R1996). There were two sets of tests. In one test, measuring discharge sound power, sensors of various sizes ranging from four inches in diameter to forty inches in diameter were installed in ducts which discharged into a sound chamber wherein the sound level was measured at 9 frequencies ranging from 63 to 8,000 hertz. Sound level was measured at various pressures (0.5 inch SP (Static Pressure), 1.0 inch SP, 2.0 inch SP and 3.0 inch SP Flow rates ranged from 75 cubic feet per minute (CFM) to 250 CFM for the 4-inch duct and sensor, and from 3,000 to 8,000 CFM for the size 40 (24″×16″) duct and sensor. The results of these tests at the second through seventh octave bands, i.e., 125, 250, 500, 1,000, 2,000, and 4,000 hertz, in ARI Certification Rating points (approximately equal to 0.8 decibels per rating point) at flow rates specified by ARI are given in Table I.A. for the older sensors, and in Table I.B. for the sensors embodying this invention. The difference between the tests are set forth in Table I.C.

Another set of tests, for radiated sound power, was conducted with sensors mounted in ducts extending through the sound chamber so that the air passing through the duct was discharged outside of the chamber. The data for the old flow sensors in these tests is recorded on Table I.D. The data for the new flow sensors is recorded in Table I.E., and the difference between the tests is recorded in Table I.F.

TABLE I

| | | Sound Power @ 1.5 IN SP | | | | | |
|---|---|---|---|---|---|---|---|
| Inlet Size | CFM | 2 | 3 | 4 | 5 | 6 | 7 |

A. Old Flowcross - ESV Discharge Sound Power
ARI Certification Rating Points

| | | | | | | | |
|---|---|---|---|---|---|---|---|
| 4 | 150 | 70 | 65 | 59 | 54 | 53 | 47 |
| 5 | 250 | 70 | 66 | 60 | 55 | 53 | 49 |
| 6 | 400 | 73 | 69 | 61 | 55 | 51 | 47 |
| 7 | 550 | 71 | 72 | 65 | 60 | 56 | 52 |
| 8 | 700 | 70 | 68 | 64 | 61 | 55 | 50 |
| 9 | 900 | 76 | 69 | 66 | 62 | 59 | 55 |
| 10 | 1100 | 78 | 70 | 65 | 61 | 57 | 53 |
| 12 | 1600 | 76 | 71 | 67 | 62 | 59 | 55 |
| 14 | 2100 | 77 | 71 | 68 | 64 | 59 | 59 |
| 16 | 2800 | 78 | 72 | 70 | 66 | 62 | 57 |
| 40 | 5300 | 88 | 81 | 80 | 77 | 75 | 70 |

B New Flowcross - ESV Discharge Sound Power
ARI Certification Rating Points

| | | | | | | | |
|---|---|---|---|---|---|---|---|
| 4 | 150 | 67 | 64 | 58 | 54 | 53 | 48 |
| 5 | 250 | 68 | 63 | 59 | 55 | 53 | 48 |
| 6 | 400 | 68 | 67 | 62 | 58 | 55 | 50 |
| 7 | 550 | 68 | 67 | 61 | 58 | 54 | 49 |
| 8 | 700 | 71 | 69 | 61 | 57 | 54 | 49 |
| 9 | 900 | 72 | 67 | 62 | 58 | 56 | 51 |
| 10 | 1100 | 73 | 68 | 64 | 62 | 58 | 53 |
| 12 | 1600 | 74 | 71 | 67 | 63 | 61 | 56 |
| 14 | 2100 | 71 | 66 | 65 | 61 | 60 | 56 |
| 16 | 2800 | 72 | 68 | 65 | 62 | 60 | 55 |
| 40 | 5300 | 83 | 79 | 77 | 73 | 72 | 67 |

C. Difference - ESV Discharge Sound Power
ARI Certification Rating Points

| | | | | | | | |
|---|---|---|---|---|---|---|---|
| 4 | 150 | −3 | −1 | −1 | 0 | 0 | 1 |
| 5 | 250 | −0 | −3 | −1 | 0 | 0 | −1 |
| 6 | 400 | −5 | −2 | 1 | 3 | 4 | 3 |
| 7 | 550 | −3 | −5 | −4 | −2 | −2 | −3 |
| 8 | 700 | 1 | 1 | −3 | −4 | −1 | −1 |
| 9 | 900 | −4 | −2 | −4 | −4 | −3 | −4 |
| 10 | 1100 | −5 | −2 | −1 | 1 | 1 | 0 |
| 12 | 1600 | −2 | 0 | 0 | 1 | 2 | 1 |
| 14 | 2100 | −6 | −5 | −3 | −3 | 1 | −3 |
| 16 | 2800 | −6 | −4 | −5 | −4 | −2 | −2 |
| 40 | 5300 | −3 | −2 | −3 | −4 | −3 | −3 |

D. Old Flowcross - ESV Radiated Sound Power
ARI Certification Rating Points

| | | | | | | | |
|---|---|---|---|---|---|---|---|
| 4 | 150 | 65 | 54 | 44 | 40 | 41 | 39 |
| 5 | 250 | 62 | 51 | 43 | 37 | 38 | 38 |
| 6 | 400 | 66 | 63 | 52 | 42 | 40 | 36 |
| 7 | 550 | 67 | 59 | 51 | 46 | 46 | 43 |
| 8 | 700 | 67 | 57 | 51 | 46 | 45 | 44 |
| 9 | 900 | 70 | 60 | 53 | 47 | 44 | 41 |
| 10 | 1100 | 72 | 59 | 53 | 48 | 45 | 43 |
| 12 | 1600 | 71 | 62 | 57 | 51 | 47 | 43 |
| 14 | 2100 | 77 | 61 | 55 | 50 | 51 | 48 |
| 16 | 2800 | 70 | 62 | 57 | 53 | 51 | 50 |
| 40 | 5300 | 76 | 71 | 70 | 65 | 60 | 54 |

E: New Flowcross - ESV Radiated Sound Power
ARI Certification Rating Points

| | | | | | | | |
|---|---|---|---|---|---|---|---|
| 4 | 150 | 59 | 56 | 45 | 41 | 40 | 35 |
| 5 | 250 | 60 | 57 | 47 | 41 | 40 | 35 |
| 6 | 400 | 62 | 60 | 50 | 43 | 40 | 36 |
| 7 | 550 | 63 | 58 | 51 | 46 | 41 | 32 |
| 8 | 700 | 64 | 58 | 52 | 46 | 45 | 42 |
| 9 | 900 | 62 | 56 | 51 | 45 | 43 | 36 |
| 10 | 1100 | 65 | 60 | 55 | 53 | 51 | 40 |
| 12 | 1600 | 65 | 60 | 57 | 51 | 48 | 42 |
| 14 | 2100 | 64 | 60 | 54 | 51 | 48 | 44 |
| 16 | 2800 | 64 | 59 | 52 | 49 | 48 | 42 |
| 40 | 5300 | 75 | 72 | 73 | 67 | 62 | 56 |

F. Difference - ESV Radiated Sound Power
ARI Certification Rating Points

| | | | | | | | |
|---|---|---|---|---|---|---|---|
| 4 | 150 | —6 | 2 | 1 | 1 | —1 | —4 |
| 5 | 250 | —2 | 6 | 4 | 4 | 2 | —3 |
| 6 | 400 | —4 | —3 | —2 | 1 | 0 | 0 |
| 7 | 550 | —4 | —1 | 0 | 0 | —5 | —11 |
| 8 | 700 | —3 | 1 | 1 | 0 | 0 | —2 |
| 9 | 900 | —6 | —4 | —2 | —2 | —1 | —5 |
| 10 | 1100 | —7 | 1 | —2 | 5 | 6 | —3 |
| 12 | 1600 | —6 | —2 | 0 | 0 | 1 | —1 |
| 14 | 2100 | —13 | —1 | —1 | 1 | —3 | —4 |
| 16 | 2800 | —6 | —3 | —5 | —4 | —3 | —8 |
| 40 | 5300 | —1 | 1 | 3 | 2 | 2 | 2 |

This data is used to generate Noise Criteria (NC) ratings, in accordance with a method of determining single-number sound ratings as first published in the Noise Control Journal in 1957, which is the most commonly used sound rating system in the heating, ventilation and air conditioning (HVAC) industry. This method estimates sound sensitivity relative to loudness and speech interference of a given sound spectrum. The criteria consist of a family of curves extending from 63 to 800 Hz. A tangency rating procedure employs these curves to define the limits of octave band spectra that must not be exceeded to meet occupant acceptance.

Building designers determine maximum NC levels for various building spaces. These are selected based upon space utilization and industry guidelines. Then equipment must be selected that produces a sound power spectrum that will result in sound pressure levels that do not exceed the NC limits for the space. Acoustic levels for various items of equipment, when used with various building components, including reflective materials such as wood, metal and glass, and absorptive materials such as carpets, upholstered furniture and certain ceiling structures, are combined to predict the overall acoustic performance of a room or building.

It is important to understand that sound spectrums rarely mimic the smooth contours of the NC criteria curves. They are often unbalanced or contain ‘spikes’ in certain frequency bands that become the defining characteristic of the product. These are referred to as ‘critical bands’. A difference of less than one dB in a critical band may be worth an NC point, while non-critical bands could change by 10 or even 20 dB without any effect on the overall NC rating. For the sensors described herein, sound bands 2 and 3 are the critical bands. As may be seen from Tables I.C. and I.F, the sensors embodying this invention were clearly superior in both of these sound bands in the discharge sound power test, were clearly superior in band 2 for the radiated sound power test, and were approximately equal to the older sensor in band 3 for the radiated sound power test. These differences are significant to architects and interior designers, who must work to cumulative acoustic specifications.

These sensors may be produced in two or three pieces, which are fused together by any of a variety of techniques, including vibratory or ultrasonic welding. Preferably, all the pieces are molded of acrylic butyl styrene or ABS. However, other materials with the requisite physical properties which are suitable for the molding and joining techniques employed may also be used.

The cylindrical low pressure hub 43 and tap 51 may be molded separately, and welded to the downstream half of the sensor. However, these pieces may also be molded integrally, using retractable mold cores to form the low pressure inlets 41 and the connecting port 49 through the low pressure tap 51.

As may be seen in FIGS. 5 and 7, there is a blind pocket 57 in the central hub of the downstream section 37, which forms part of the high pressure-averaging chamber 27. This helps to provide comparable wall thicknesses throughout the downstream section of the sensor, which helps to avoid molding problems. The conduits 25 in the arms 15 are also designed to provide relatively constant wall thickness. As seen in FIG. 7, the inner walls 38 of the downstream section of the sensor and the inner walls 18 of the upstream section 17 of the sensor have a substantially constant thickness from the inlet port 21 to the central axis of the sensor.

As best seen in FIGS. 5 and 6, the outer or mounting end of each arm is molded as an integral piece with two semi-circular halves. The upstream half continues the aerodynamic surface 19 which extends from the center of the sensors. The bottom side of this mounting section, as shown in FIGS. 5 and 6, is a somewhat smaller semi-cylindrical or tubular piece 16. This reduces the amount of molding material required. As seen in FIG. 5, to provide assembly tolerance, a thin slot 34 is provided between the outer end of bottom section 37 and the inner end of the semi-cylindrical end piece 16.

These sensors may be easily installed in round ducts, as shown in FIG. 3, by inserting screws or other fasteners through the walls of the ducts into holes 14 in the end of each arm. As shown in FIG. 4, sensors may also be installed in pairs or other multiples in rectangular or other ducts. Other configurations will be readily apparent to those skilled in the art.

As may be seen from the foregoing, this invention provides a sensor that is effective, rugged, and economical to manufacture. It produces averaged and amplified pressure signals that are comparable to those provided by other amplifying and averaging sensors, with substantially improved acoustic performance. With ever tightening indoor environmental controls and standards, this is a significant advantage.

Of course, those skilled in the art will readily appreciate that many modifications may be made in the structure disclosed above. The foregoing description is merely illustrative, and is not meant to limit the scope of this invention, which is defined by the following claims.

We claim:

1. Apparatus for sensing flow rates comprising:
an aerodynamic upstream surface with at least one high-pressure fluid inlet in a central portion of said aerodynamic surface; and
a blunt downstream surface that creates a reduced pressure zone adjacent to said blunt surface, and
at least one low-pressure inlet located in said reduced pressure zone.

2. Apparatus according to claim 1 wherein said aerodynamic surface is curved, faceted or wedge-shaped.

3. Apparatus according to claim 2 wherein said aerodynamic surface is semicircular, parabolic or elliptical

4. Apparatus according to claim 1 wherein said blunt surface is substantially flat or concave.

5. Apparatus according to claim 1 wherein said blunt surface is substantially flat and is substantially normal to a primary direction of fluid flow past said apparatus

6. Apparatus according to claim 1 further comprising a plurality of arms extending outward from a central hub, at least one of said arms having:
a least one of said aerodynamic upstream surfaces with at least one of said high-pressure fluid inlets and
at least one of said blunt downstream surfaces that creates said reduced pressure zone adjacent to said blunt surface.

7. Apparatus according to claim 6 wherein said high-pressure inlet is located on or near the lateral axis of said arm.

8. Apparatus according to claim 1 wherein each of said arms comprises an arm conduit extending from said high-pressure inlet to a central junction.

9. Apparatus according to claim 8 wherein:
said apparatus comprises a high pressure tap, a low pressure tap, a common conduit from said central junction to said high pressure tap, a low pressure conduit from said low pressure inlet to said low pressure tap, and an airflow controller having a high-pressure inlet and a low-pressure inlet;
said high pressure inlets are connected through said arm conduits, said common conduit and said high pressure tap to said high pressure inlet of said airflow controller, and
said low pressure inlet is connected through said low pressure conduit and said low pressure tap to said low pressure inlet of said airflow controller.

10. A signal-amplifying sensor comprising:
an aerodynamic upstream surface with at least one high pressure fluid inlet;
a blunt downstream surface that creates a reduced pressure zone adjacent to said blunt surface; and
at least one low pressure inlet located in said reduced pressure zone.

11. A signal-amplifying sensor according to claim 10, further comprising a plurality of arms extending outwardly from a central axis, said arms comprising:
an upstream side having an aerodynamic face, at least one high pressure fluid inlet in a central portion of said aerodynamic face, and a conduit extending from said high-pressure inlet to a central junction; and
a downstream portion having a blunt face that creates a reduced pressure zone adjacent to said blunt face.

12. A signal-amplifying sensor according to claim 10 wherein said aerodynamic face is semicircular, parabolic or elliptical, and said high pressure inlet is located on or near the lateral axis of said aerodynamic surface.

13. A signal-amplifying sensor according to claim 12 further comprising:
a high pressure tap, a common conduit from said central junction to said high pressure tap; and
a low pressure tap, at least one low pressure inlet located in said reduced pressure zone, and a low pressure conduit from said low pressure inlet to said low pressure tap.

14. An airflow control system comprising a sensor having a plurality of arms extending outwardly from a central axis, said arms comprising:
an upstream side having an aerodynamic face, at least one high pressure fluid inlet in a central portion of said aerodynamic face, and an arm conduit extending from said high pressure inlet to a central junction;
a downstream portion having a blunt face that creates a reduced pressure zone adjacent to said blunt face;
at least one low pressure inlet located in said reduced pressure zone, a low pressure tap, and a low pressure conduit from said low pressure inlet to said low pressure tap;
a high pressure tap, a common conduit from said central junction to said high pressure tap; and
an airflow controller with a high pressure inlet and a low pressure inlet, said high pressure inlets being connected through said arm conduits, said common conduit and said high pressure tap to said high pressure side of said airflow controller, and said low pressure inlet being connected through said low pressure conduit and said low pressure tap to a low pressure side of said airflow controller.
